(19) United States
(12) Patent Application Publication
(10) Pub. No.: US 2015/0046200 A1
(43) Pub. Date: Feb. 12, 2015

(54) CHARGER RESERVATION SYSTEM, CHARGER RESERVATION APPARATUS, CHARGER RESERVATION METHOD, AND PROGRAM

(71) Applicant: NEC CORPORATION, TOKYO (JP)

(72) Inventor: Shinpei Chihara, Tokyo (JP)

(21) Appl. No.: 14/384,691

(22) PCT Filed: Mar. 5, 2013
(86) PCT No.: PCT/JP2013/056015

§ 371 Date: Sep. 12, 2014

(30) Foreign Application Priority Data
Mar. 14, 2012 (JP) 2012-057487

(51) Int. Cl. G06Q 10/02

(52) U.S. Cl. CPC G06Q 10/02
USPC 705/5

(57) ABSTRACT

The charger reservation system has: a reservation processing unit that receives a use reservation registration for a charger and manages reservation information containing a use starting date/time and a temporary use ending date/time; and a charge required time calculation unit that calculates a time required for charging when a user starts using the charger based on the use reservation registration, wherein the reservation processing unit calculates a new use ending date/time based on the time required for charging and updates the temporary use ending date/time to the new use ending date/time.

### BACKGROUND

The present invention relates to a charger reservation system, a charger reservation apparatus, a charger reservation method, and a program.

Even with a quick charger, it takes approximately several tens of minutes to an hour to charge a rechargeable battery in an electric vehicle. Upon arrival of a user at the location where there is a charger, if there is another user who is already using or waiting to use the charger, the waiting time before the charger becomes available could be extremely long. What is desired in order to avoid such situation is a service that allows making a reservation for the use of a charger during a desired time period.

Patent Document 1, for example, describes a system in which a server manages an installation location of an outlet with a unique outlet ID, as well as the type of the outlet (the shape, voltage, current, etc.), a web server receives a reservation for the use of the outlet on a certain date/time or for a required amount of electric energy, and the supply of electricity to a connected device is controlled based on the information of the reservation.

Patent Document 2, on the other hand, discloses a system in which a management server integrally manages a charge reservation that is input to a charger in each charging station, and sends an electronic mail to a user waiting to charge his/her electric vehicle to notify about the availability of a charger when the charger becomes available due to a cancellation of the reservation therefor.

Patent Document 1: Patent Publication JP-A-2008-263712

Patent Document 2: Patent Publication JP-A-2010-267110

However, when a user makes a reservation for a charger, the conventional systems make it difficult for the user to accurately estimate a time required and set a reservation time, because the time it takes to charge an electric vehicle is determined by such factors as the remaining capacity of the rechargeable battery of the electric vehicle, the temperature, and the output of the rechargeable battery. Especially when the time it actually took to charge the user's electric vehicle is shorter than the charging time set for the reservation by the user, the next user is not able to use the charger although the previous charging has actually been finished, until the ending time that was originally registered by the user is past. It is impossible for the methods described in Patent Documents 1 and 2 to avoid such situation or utilize a charger efficiently and adequately.

### SUMMARY

An exemplary object of the present invention, therefore, is to realize efficient utilization of a charger.

A charger reservation system according to the present invention has: a reservation processing unit that receives a use reservation registration for a charger and manages reservation information containing a use starting date/time and a temporary use ending date/time; and a charge required time calculation unit that calculates a time required for charging when a user starts using the charger based on the use reservation registration, wherein the reservation processing unit calculates a new use ending date/time based on the time required for charging and updates the temporary use ending date/time to the new use ending date/time.

A charger reservation apparatus according to the present invention has: a reservation processing unit that receives a use reservation registration for a charger and manages reservation information containing a use starting date/time and a temporary use ending date/time; and a charge required time calculation unit that calculates a time required for charging when a user starts using the charger based on the use reservation registration, wherein the reservation processing unit calculates a new use ending date/time based on the time required for charging and updates the temporary use ending date/time to the new use ending date/time.

A charger reservation method according to the present invention has: receiving a use reservation registration for a charger and managing reservation information containing a use starting date/time and a temporary use ending date/time; calculating a time required for charging when a user starts using the charger based on the use reservation registration; and calculating a new use ending date/time based on the time required for charging and then updating the temporary use ending date/time to the new use ending date/time.

A program according to the present invention causes a computer to function as: a reservation processing unit that receives a use reservation registration for a charger and manages reservation information containing a use starting date/time and a temporary use ending date/time; and a charge required time calculation unit that calculates a time required for charging when a user starts using the charger based on the use reservation registration, wherein the reservation processing unit calculates a new use ending date/time based on the time required for charging and updates the temporary use ending date/time to the new use ending date/time.

An exemplary aspect of the present invention is capable of realizing efficient utilization of a charger.

### DESCRIPTION OF DRAWINGS

FIG. 1 is a block diagram showing a configuration of a charger reservation system according to Embodiment 1 of the present invention;

FIG. 2 is a diagram showing a configuration example of a user information DB according to Embodiment 1 of the present invention;

FIG. 3 is a diagram showing a configuration example of a charger information DB according to Embodiment 1 of the present invention;

FIG. 4 is a diagram showing a configuration example of a reservation information DB according to Embodiment 1 of the present invention;

FIG. 5 is a sequence diagram of a process executed when a user makes a reservation for the use of a charger, according to Embodiment 1 of the present invention;

FIG. 6 is a flowchart of a reservation registration process according to Embodiment 1 of the present invention;

FIG. 7 is a sequence diagram showing a process executed when the user uses the reserved charger, according to Embodiment 1 of the present invention;

FIG. 8 is a flowchart of a process for updating a use ending time, according to Embodiment 1 of the present invention;

FIG. 9 is a diagram showing a configuration example of a user information DB according to Embodiment 2 of the present invention; and

FIG. 10 is a sequence diagram showing a process executed when the user uses the reserved charger, according to Embodiment 2 of the present invention.

### EXEMPLARY EMBODIMENT

### Embodiment 1

Modes for implementing the present invention are described hereinafter in detail with reference to the drawings.

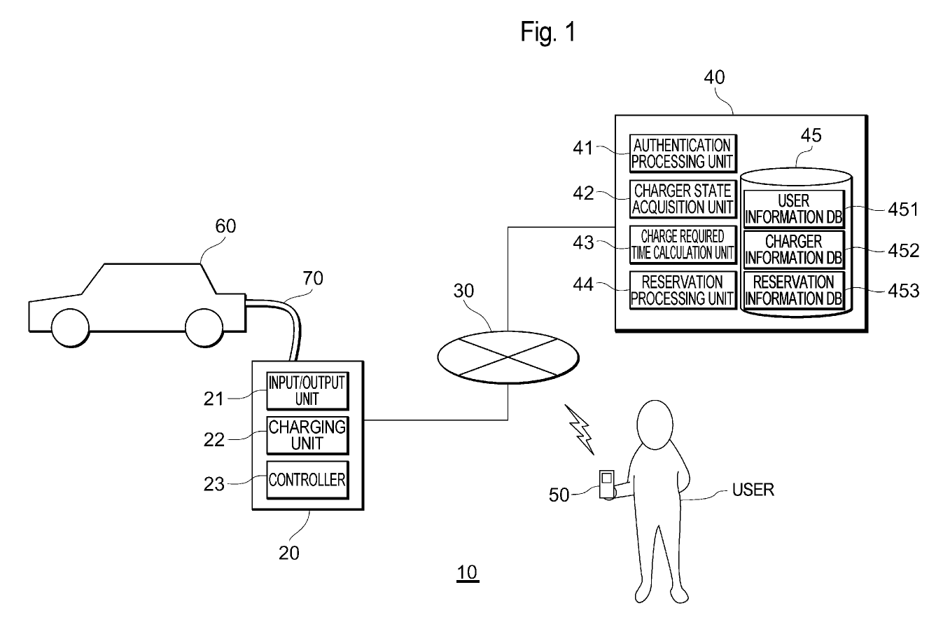

FIG. 1 is a block diagram showing a configuration of a charger reservation system 10 according to Embodiment 1 of the present invention. As shown in the diagram, the charger reservation system 10 has a charger 20 for charging a rechargeable battery of an electric vehicle 60, a server device 40 connected to the charger 20 by a network 30, and a terminal 50 used by a user, which is connected to the server device 40 by the network 30.

The charger 20 has an input/output unit 21, a charging unit 22, and a controller 23.

The input/output unit 21 is a device with input/output functions, such as a touch panel display or an IC card reader/writer, and has an information input function for receiving a user operation and reading a membership card to identify whether the user is a registered member or not, and an information output function for outputting information such as operation results and authentication results.

The charging unit 22 functions to charge the electric vehicle 60 that is connected thereto by a charging cable 70.

The controller 23 functions to control the operations of the charger 20 based on a user operation received through the terminal 50 or the instructions transmitted from the server device 40.

The server device 40 has an authentication processing unit 41, a charger state acquisition unit 42, a charge required time calculation unit 43, a reservation processing unit 44, and a storage unit 45. A specialized or general-purpose computer that has a CPU, a memory such as a ROM or RAM, an external storage device for storing a variety of information, an input interface, an output interface, a communication interface, and a bus connecting these elements, can be employed as the server device 40. The server device 40 may be configured by a single computer or a plurality of computers connected to one another by a communication line.

The authentication processing unit 41, the charger state acquisition unit 42, the charge required time calculation unit 43, and the reservation processing unit 44 correspond to functional modules that are realized by the CPU executing predetermined programs stored in the ROM or the like. The storage unit 45 is implemented by the external storage device.

The authentication processing unit 41 not only functions to identify whether a user is registered as a member allowed to use the charger 20 or not, but also functions to identify whether a user who wishes to use the charger 20 has a reservation for the charger 20 or not.

The charger state acquisition unit 42 functions to acquire the state of the charger 20 from the charger 20.

The charge required time calculation unit 43 functions to calculate the time it takes to complete charging a predetermined amount of electric energy, based on the remaining capacity of the rechargeable battery of the electric vehicle 60, the ambient temperature, an output status of the charger 20, and the like.

The reservation processing unit 44 functions to accept a reservation registration request from a user through the terminal 50. Note that reservation registration may be performed using another method without using the terminal 50. For example, the user may be allowed to register a reservation by using input means provided in the charger 20. Alternatively, a reservation may be registered using a reservation apparatus that is provided separately.

Databases for compiling user information, charger information and reservation information are mounted in the storage unit 45. The databases include a user information DB 451 for retaining the information on users allowed to use chargers and make reservations for the chargers, a charger information DB 452 for retaining the information such as the names of the chargers and the installation locations of the chargers, and a reservation information DB 453 for managing the reservation status of each charger.

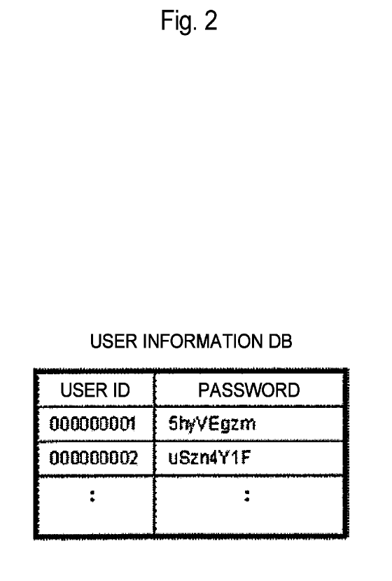

FIG. 2 is a diagram showing a configuration example of the user information DB 451. The user information DB 451 retains a “user ID,” information for identify the users, and a “password” which is used in an authentication process performed when a user starts using the charger 20 or registers a reservation for the charger 20.

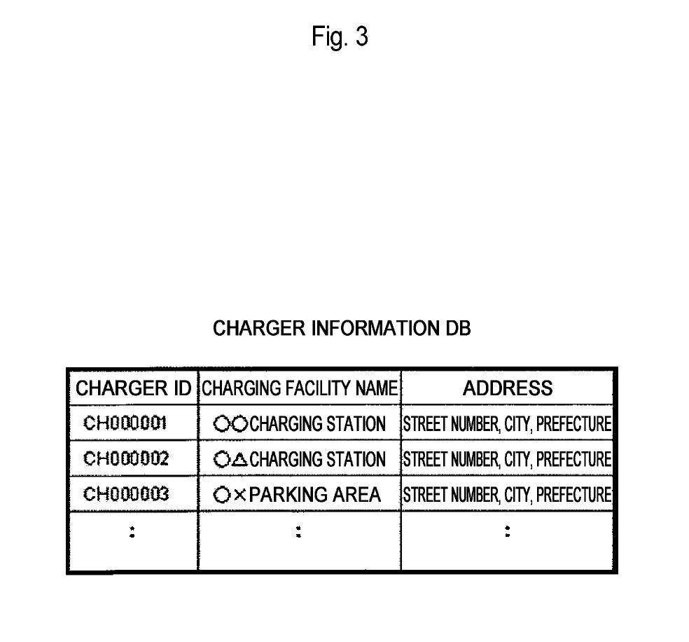

FIG. 3 is a diagram showing a configuration example of the charger information DB 452. The charger information DB retains a “charger ID,” information for identifying the chargers 20, a “charging facility name” showing the names of the facilities where the chargers 20 are set up, and an “address” of each place where each charger 20 is set up.

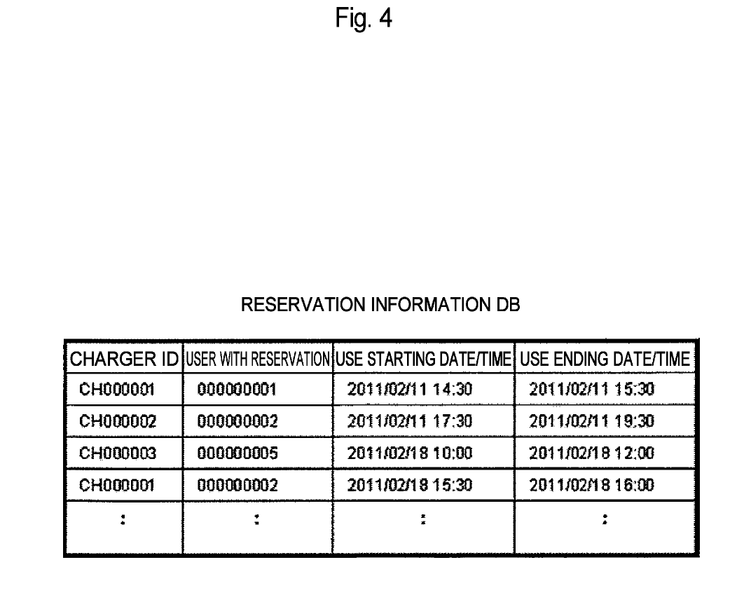

FIG. 4 is a diagram showing a configuration example of the reservation information DB 453. The reservation information DB 453 retains a “charger ID,” information for identifying the chargers 20, a “user with reservation,” the user ID of a user who has a reservation for a charger 20, a “use starting date/time” showing a use starting date/time for which a reservation is made, and a “use ending date/time” showing a use ending date/time for which the reservation is made.

The terminal 50 is a device that is connected to the server device 40 by the network 30 and used by a user to view or register the reservation information of the user. The terminal 50 is a mobile terminal such as a cellular phone, or an information processing terminal such as a personal computer.

Note that the configuration of the charger reservation system 10 is not limited to the one shown in FIG. 1. Thus, for example, each of the functions of the server device 40 or a part of the storage unit 45 may be mounted in the chargers 20 or the terminal 50.

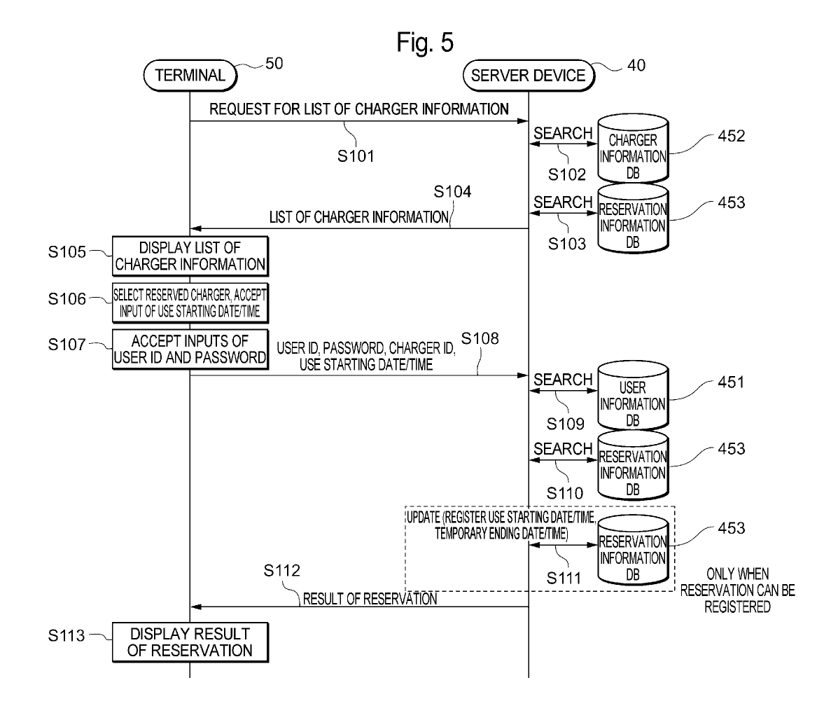

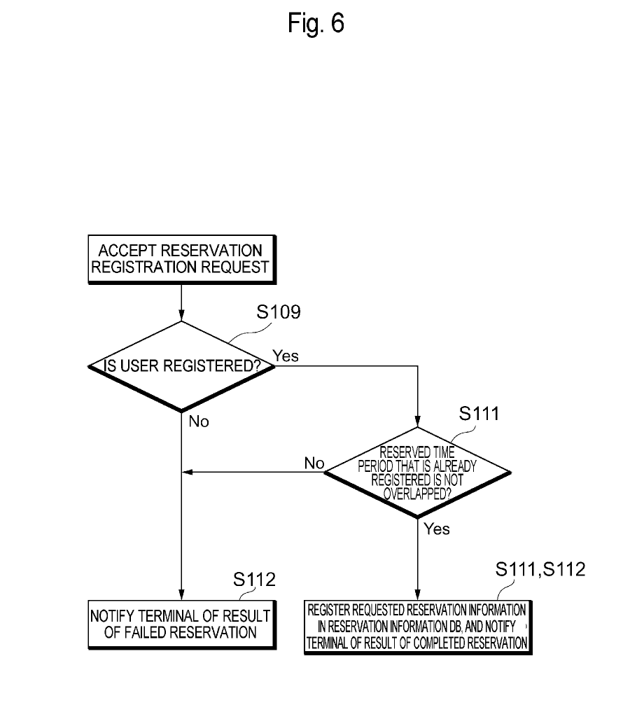

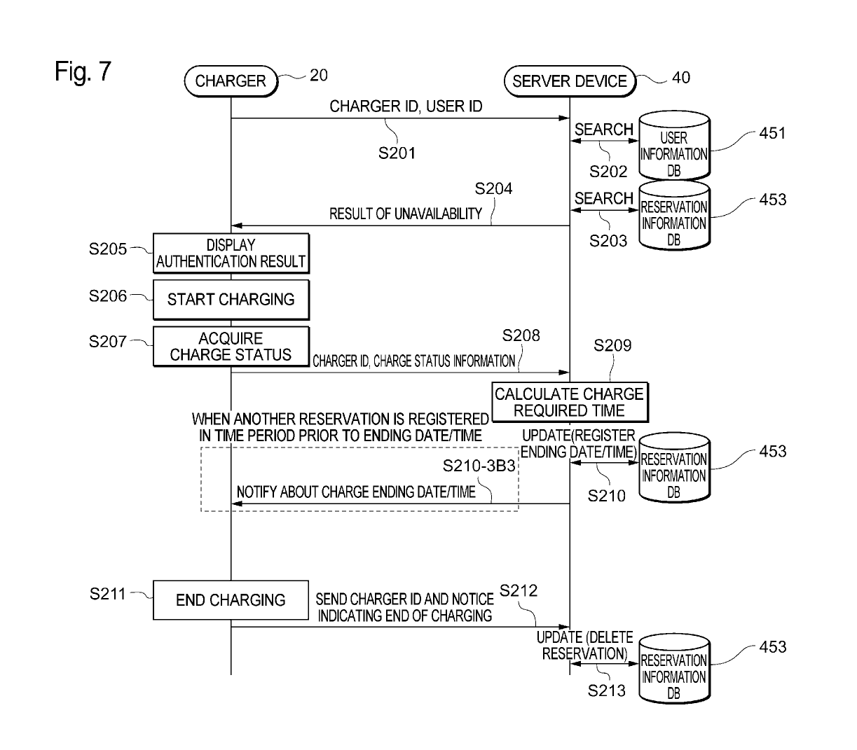

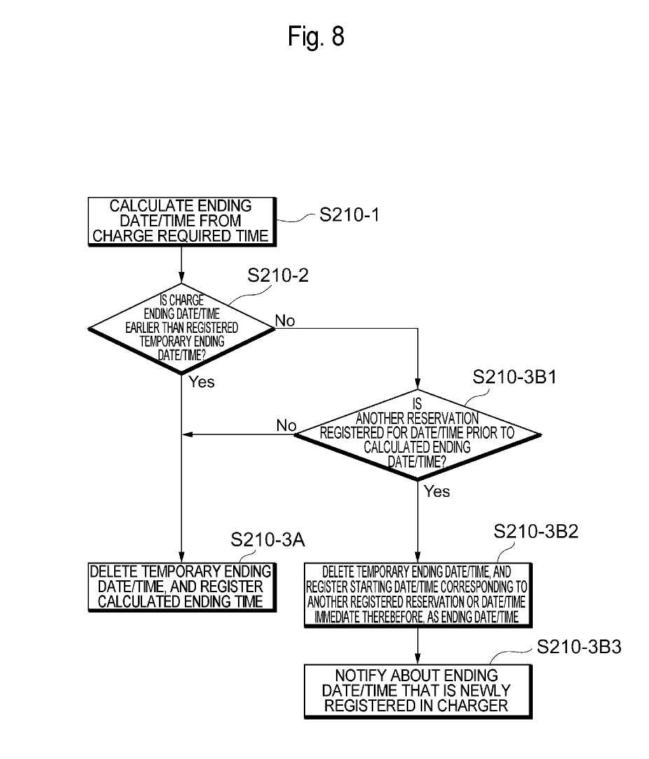

The operations of the charger reservation system 10 are described next with reference to FIGS. 5 to 8. FIG. 5 is a sequence diagram of a process executed when a user makes a reservation for the use of a charger 20. FIG. 6 is a flowchart of a reservation registration process performed by the server device 40. FIG. 7 is a sequence diagram showing a process executed when the user uses the reserved charger. FIG. 8 is a flowchart of a process for updating the use ending time after the use of the charger is started.

The process executed when a user makes a reservation for the use of a charger 20 is now described with reference to FIGS. 5 and 6.

First, the user operates a menu screen on the terminal 50 to request the server device 40 to send a list of information on available chargers 20 (S101). In response to the request, the server device 40 causes the reservation processing unit 44 to search the charger information DB 452 to acquire a list of the registered charger information (S102). Furthermore, the reservation processing unit 44 searches the reservation information DB 453 to acquire a reservation status of each charger that is acquired in step S102 (S103).

The server device 40 transmits the information acquired in steps S102 and S103 (the list of charger information) to the terminal 50 (S104). The terminal 50 then displays the acquired list of charger information on the screen of the terminal 50 (S105). Note that, in step S101 where the list of charger information is requested, the user may operate the terminal 50 to provide the server device 40 with the name of the region or the address where the user is, and the reservation processing unit 44 may search only for the information on a charger located in this provided region or at this provided address. This allows the user to narrow down the information that the user wishes to acquire.

In addition, the user may keep map data in the server device 40 or the terminal 50 and register coordinate information such as the latitude and longitude of the installation location of each charger in the charger information DB 452. When the user designates a predetermined range on the map by using a GUI (graphical user interface), the server device 40 may provide the user with the information on the chargers located within the range. The terminal 50 may be provided with a GPS function so that the information on the chargers located within a predetermined range from the current position of the user can be provided.

Next, from the list of charger information acquired in step S105 through the operation on the terminal 50, the user selects a charger that the user wishes to reserve, and inputs a use starting date/time (S106). The user also inputs his/her user ID and password (S107). The terminal 50 transmits these input information to the server device 40 (S108).

The server device 40 causes the authentication processing unit 41 to first search the user information DB 451 and check whether or not there is registered in the user information DB 451 a record showing the same combination of a user ID and password as the combination of the user ID and password acquired from the terminal 50 (FIGS. 5 and 6: S109). When the user is not registered (No), it is determined that the user authentication has failed, and this result of the unsuccessful reservation is sent to the terminal 50 (FIGS. 5 and 6: S112).

When it is determined in step S109 that the user is registered (Yes), it is determined that the user authentication is successful, the reservation processing unit 44 searches the reservation information DB to acquire the reservation information corresponding to the charger ID acquired from the terminal 50 (S110). Next, the reservation processing unit 44 sets a certain time after the use starting date/time acquired from the terminal 50 (30 minutes, 1 hour or the like after the acquired use starting date/time), as a temporary use ending date/time, and checks whether the time period between the acquired use starting date/time and the temporary use ending date/time overlaps with the reserved time period that is contained in the reservation information acquired in step S110 (S111).

When the reserved time overlaps (S111: No), the reservation processing unit 44 determines that the reservation cannot be made, and notifies the terminal of the result of the unsuccessful reservation (S112). When the reserved time does not overlap (S111: Yes), the reservation processing unit 44 determines that the reservation can be made, and registers, in the reservation information DB 453, the reservation information having a combination of the user ID, charger ID, use starting date/time, and abovementioned temporary use ending date/time acquired from the terminal 50 (S111). Subsequently, the result of the successful reservation is sent to the terminal 50 (S112). Upon reception of the reservation result from the server device 40, the terminal 50 then displays the reservation result on the screen thereof (S113).

The temporary use ending date/time to be registered in the reservation information DB 453 may be calculated by the reservation processing unit 44 as described above or may be input by the user in step S106.

Next is described, with reference to FIGS. 7 and 8, the process executed when the user who reserved the charger 20 uses the charger to perform charging.

When using the charger 20, the user first causes the input/output unit 21 of the charger 20 to read his/her membership card. The charger 20 then transmits to the server device 40 the read user ID and the charger ID that is recorded in the charger 20 beforehand (S201).

The server device 40 causes the authentication processing unit 41 to search the user information DB 451 and check whether the user ID received from the charger 20 is registered in the user information DB 451 or not (S202). When the user ID is not registered, the authentication processing unit 41 determines that the authentication has failed, notifies the charger 20 of the result indicating unavailability thereof, and ends the process (S204).

When the user ID is registered, the authentication processing unit 41 searches the reservation information DB 453, and checks, in relation to the charger ID transmitted from the charger 20, whether or not there is a reservation for this charger for a certain period of time from the current time (for 30 minutes, 1 hour, etc.). If there is a reservation, whether or not this reservation is the same as the reservation made by the user with the user ID transmitted in step S201, is checked (S203).

If this reservation is a reservation made by a different user, the authentication processing unit 41 determines that the charger is not available, sends the result of the determination to the charger 20, and ends the process (S204). If the reservation is the one made by the same user, or if there is no reservation made by any user during the time period, the authentication processing unit 41 determines that the charger is available, and notifies the charger 20 of the result of the determination (S204).

In response to the result from the server device 40, the result indicating the availability of the charger, the charger 20 causes the input/output unit 21 to display an authentication OK message and a menu screen showing a button for starting a charging operation on the electric vehicle (S205).

Once the user connects the charging cable 70 to the electric vehicle 60 and selects the menu on the input/output unit 21 of the charger 20 to begin charging, the controller 23 of the charger 20 instructs the charging unit 22 to begin charging, in response to which the charger 20 starts charging the electric vehicle 60 (S206).

Next, the charging unit 22 acquires the remaining capacity of the rechargeable battery, the temperature of the rechargeable battery, and the target charged electric energy or charging rate from the electric vehicle 60 in process of charging, and acquires a combination of these information, a charging voltage value, and a charging current value, as charge status information (S207).

When the temperature of the rechargeable battery cannot be acquired, a thermometer may be attached to the charger 20, and the temperature obtained by the thermometer may be included in the charge status information.

A value that is set beforehand in the charger 20 may be used as the target charged electric energy or charging rate. Alternatively, the menu screen that allows the user to start a charging operation may display a menu for designating the target charged electric energy or charging rate, to allow use of the value selected through the user operation.

The charging unit 22 transmits the acquired charge status information to the server device 40 along with the charger ID of the charger 20 (S208).

The charge required time calculation unit 43 of the server device 40 calculates a charge required time based on the charge status information transmitted from the charger 20 (S209).

Specific examples of a method for calculating a charge required time are now described. The charge required time calculation unit 43 may retain graph data showing the relationship between a remaining capacity of the rechargeable battery and a charge required time, and calculate a charge required time that is required for the remaining capacity, which is included in the charge status information acquired from the charger 20, to reach the target charged electricity energy or charging rate.

The graph data may be prepared for each type of electric vehicle. The information specifying the types of electric vehicles held by corresponding users may be added to the user information DB 451 in advance, so that the type of the electric vehicle 60 in process of charging can be specified from the corresponding user ID and a more accurate charge required time can be calculated based on the graph data prepared for each vehicle type.

As study data, the past charge status information may be used together with log information on the charge required time that it actually took. Then, by means of a machine learning method, a charge required time may be calculated from the charge status information acquired in step S208.

Next, based on the charge required time calculated in step S209, the reservation processing unit 44 updates the temporary use ending date/time registered in reservation information DB 453 (S210).

The process for updating the use ending date/time is now described in detail with reference to FIG. 8.

First, a charge ending date/time is calculated based on the calculated charge required time and the current time (S210-1). Next, it is determined whether the charge ending date/time calculated in step S210-1 is earlier than the temporary use ending date/time registered in the reservation information DB 453 (S210-2).

If the calculated charge ending date/time is earlier than the temporary use ending date/time registered in the reservation information DB 453 (Yes), then the temporary use ending date/time is deleted, and the ending date/time calculated in step S210-1 is registered as a use ending date/time corresponding to the reservation information (S210-3A).

If the charge ending date/time calculated in step S210-1 is later than the temporary use ending date/time (No), the reservation information DB 453 is referenced, and whether or not there exists another reservation in a time period prior to the ending date/time calculated in step S210-1, is checked (S210-3B1).

If there is no other reservation (No), the process shifts to step S210-3A. If there is another reservation (Yes), the temporary use ending date/time corresponding to the reservation information of the user charging his/her electric vehicle is deleted, and a use starting date/time that is the same as the use starting date/time corresponding to this other reservation information or a date/time immediately before the use starting date/time corresponding to the reservation information (a date/time that is earlier by a certain margin) is registered as the use ending date/time (S210-3B2). Next, the reservation processing unit 44 notifies the charger 20 of a use ending date/time that is newly registered with respect to the charger 20 (S210-3B3).

The controller 23 of the charger 20 then instructs the charging unit 22 to end the charging when the charging is completed until the target charged electric energy or charging rate is reached or when the use ending date/time notified by the server device 40 in step S210-3B3 is reached, and consequently the charging unit 22 ends the charging (S211).

Note that a menu with a button for pausing charging may be displayed on the screen of the input/output unit 21 of the charger 20, so that charging can be ended when the user selects the pause button. Alternatively, charging may be ended in case of an abnormality in the charger 20 or the electric vehicle 60 during the charging or when charging is no longer doable.

When the charging is ended, the charging unit 22 transmits to the server device 40 the charger ID and a notice indicating that the charging is ended (S212).

In response to the notice indicating the end of charging, the server device 40 causes the reservation processing unit 44 to delete the reservation information corresponding to this notice from the reservation information registered in the reservation information DB 453 (S213). Specifically, the reservation processing unit 44 searches the reservation information registered in the reservation information DB 453 to find the reservation information that not only includes the charger ID transmitted in step S212 but also indicates that the time at which the notice is transmitted or received in step S212 falls within the time period between the use starting date/time the use ending date/time, and then deletes the relevant record. It should be noted that certain margins may be provided before and after the time period between the use starting date/time and the use ending date/time to determine whether the time at which the notice indicating the end of charging is transmitted or received falls within this time period.

In the present embodiment, the process between steps S207 to S210-3A or S210-3B is executed only once after charging is started; however, the series of steps may be repeatedly executed during the charging, on a regular basis, or when the charge status information is changed.

Furthermore, the functions of the charge required time calculation unit 43 may be mounted in the electric vehicle 60 so that the electric vehicle 60 can calculate a charge required time and the server device 40 can then update the use ending date/time in response to the charge required time calculated by the electric vehicle 60.

According to the present embodiment described above, the use ending date/time is updated based on the accurate charge ending date/time calculated based on the charge status upon the start of the use of the charger 20. Such a configuration of the present embodiment can reduce the amount of time that a user wastes on the charger 20 as a result of reserving the charger 20 for a length of time longer than necessary. The present embodiment, therefore, can realize efficient utilization of the charger.

### Embodiment 2

In Embodiment 2, when a user having a reservation for a charger starts charging and a use ending time is confirmed, the reserved use starting date/time is carried to the next user having a reservation for the charger.

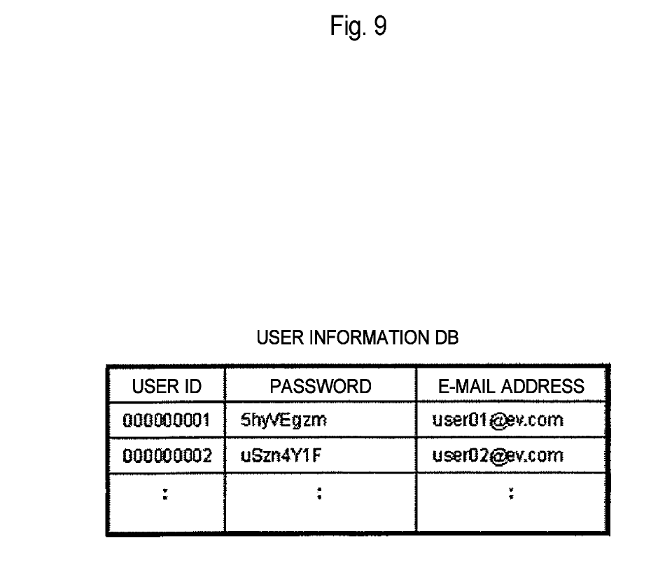

FIG. 9 is a diagram showing a configuration example of the user information DB 451 according to Embodiment 2. This embodiment is different from Embodiment 1 in that an e-mail address of a user is added to the user information DB 451. The rest of the configurations described in Embodiment 2 are the same as those of Embodiment 1.

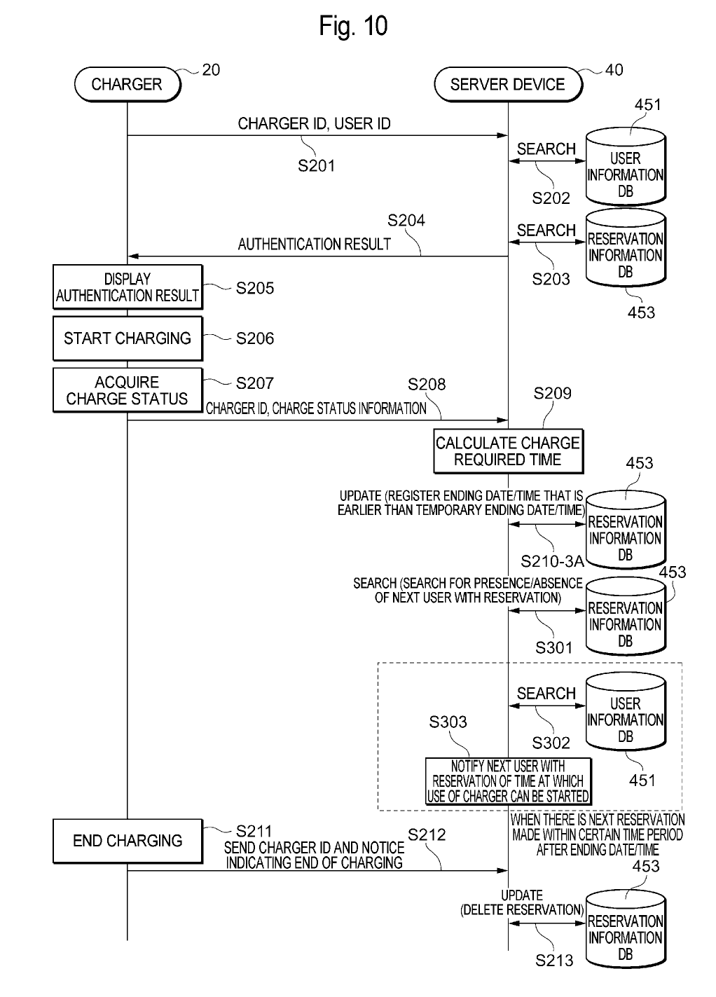

FIG. 10 is a sequence diagram showing a process executed when the user uses the reserved charger, according to Embodiment 2. The same reference numerals are used to describe the processes same as those shown in FIG. 7 of Embodiment 1.

In the present embodiment, when the newly registered use ending date/time of the user using the charger 20 is earlier than the temporary use ending date/time that is registered at the time of reservation registration, a user who has a reservation for the same charger 20 for the next time period is notified of that fact that the use starting date/time set by this user can be moved up.

When, in step S210-3A, the reservation processing unit 44 of the server device 40 confirms that the use ending date/time that is set by the user who starts using the charger 20 is changed to a date/time that is earlier than the temporary ending date/time, the reservation processing unit 44 searches the reservation information DB 453 and checks whether or not a reservation of another user for the same charger 20 is registered within a predetermined time period from the abovementioned use ending date/time (S301).

When a reservation of another user is registered within the predetermined time period, the reservation user ID contained in the corresponding reservation information is acquired, the user information DB 451 is searched based on the acquired user ID, and an e-mail address of the corresponding user is acquired (S302).

Furthermore, reservation processing unit 44 can transmit, to the acquired e-mail address, an electronic mail that includes a message describing that the use ending date/time registered newly in step S210-3A and the reserved use starting date/time can be moved up (S303). When in S301 the reservation processing unit 44 confirms that a reservation of another user is not registered within the predetermined time period, steps S302 and S303 are not executed.

According to the present embodiment, when it is found out that the use ending date/time set by a user on a charger 20 ends sooner than the temporary use ending date/time that is registered at the time of reservation registration, the next user having a reservation for the same charger 20 can be notified about that his/her use starting date/time can be moved up. Such a configuration can efficiently reduce the amount of time that a user wastes on the charger 20 as a result of reserving the charger 20 for a length of time longer than necessary. The present embodiment, therefore, can realize efficient utilization of the charger. The present embodiment can also improve convenience for the users by informing the users with reservations of that the reservations can be pushed forward.

Note that the present embodiment can notify the next user with a reservation, by electronic mail, of that the use starting date/time of the user can be pushed forward, wherein the notified user executes the actual reservation change process. However, the method of the actual reservation change process is not limited thereto. For instance, a plurality of desired use starting dates/times may be registered at the time of reservation registration, and, at the time when the use starting date/time set by the user can be pushed forward, the reservation processing unit 44 may automatically change the use starting date/time to the earliest desired use starting date/time possible and send the user an e-mail describing that his/her use starting date/time has been changed.

The present invention relates to a charging service for electric vehicles and can be applied to a charge reservation system that realizes efficient utilization of a charger, a charger with a reservation function, and a server device or program for realizing the charge reservation system and the charger.

This application claims priority based on Japanese Patent Application No. 2012-57487 filed on Mar. 14, 2012, the entire disclosure of which is hereby incorporated.

The claimed invention was described above with reference to the embodiments; however, the claimed invention is not limited to these embodiments. Various changes that can be understood by those skilled in the art can be made to the configurations and details of the claimed invention within the scope of the claimed invention.

All or part of the embodiments can be described as the additional notes provided below, but is not limited thereto.

(Addition 1) A charger reservation system, having:

a reservation processing unit that receives a use reservation registration for a charger and manages reservation information containing a use starting date/time and a temporary use ending date/time; and

a charge required time calculation unit that calculates a time required for charging when a user starts using the charger based on the use reservation registration,

wherein the reservation processing unit calculates a new use ending date/time based on the time required for charging and updates the temporary use ending date/time to the new use ending date/time.

(Addition 2) The charger reservation system according to the additional note 1, wherein, when the new use ending date/time is later than a use starting date/time set for a next reservation for the charger, the reservation processing unit updates the temporary use ending date/time to the use starting date/time set for the next reservation or a date/time that is earlier than the use starting date/time set for the next reservation by a certain time period.

(Addition 3) The charger reservation system according to the additional note 1 or 2, wherein, when the new use ending date/time is earlier than the temporary use ending date/time, the reservation processing unit notifies a user, who has a reservation for the charger next, that a use starting date/time of the user can be pushed forward.

(Addition 4) The charger reservation system according to the additional note 3, wherein, when a reservation for the use of the charger is registered, and a registration of a desired use starting date/time that overlaps with a usage time of another reservation is received, then the usage time no longer overlaps as a result of updating a temporary use ending date/time of the other reservation, the reservation processing unit updates the use starting date/time of the user to the desired use starting date/time.

(Addition 5) The charger reservation system according to any one of the additional notes 1 to 4, wherein the charge required time calculation unit calculates the time required for charging based on at least one of a remaining capacity of a rechargeable battery to be charged, a temperature, and an output status of the charger.

(Addition 6) A charger reservation apparatus, having:

a reservation processing unit that receives a use reservation registration for a charger and manages reservation information containing a use starting date/time and a temporary use ending date/time; and

a charge required time calculation unit that calculates a time required for charging when a user starts using the charger based on the use reservation registration,

wherein the reservation processing unit calculates a new use ending date/time based on the time required for charging and updates the temporary use ending date/time to the new use ending date/time.

(Addition 7) A charger reservation method, having:

receiving a use reservation registration for a charger and managing reservation information containing a use starting date/time and a temporary use ending date/time;

calculating a time required for charging when a user starts using the charger based on the use reservation registration; and

calculating a new use ending date/time based on the time required for charging and then updating the temporary use ending date/time to the new use ending date/time.

(Addition 8) A program that causes a computer to function as:

a reservation processing unit that receives a use reservation registration for a charger and manages reservation information containing a use starting date/time and a temporary use ending date/time; and

a charge required time calculation unit that calculates a time required for charging when a user starts using the charger based on the use reservation registration,

wherein the reservation processing unit calculates a new use ending date/time based on the time required for charging and updates the temporary use ending date/time to the new use ending date/time.

10 Charger reservation system, 20 Charger, 21 Input/output unit, 22 Charger, 23 Controller, 30 Network, 40 Server device, 41 Authentication processing unit, 42 Charger state acquisition unit, 43 Charge required time calculation unit, 44 Reservation processing unit, 45 Storage unit, 50 Terminal, 60 Electric vehicle, 70 Charging cable, 451 User information DB, 452 Charger information DB, 453 Reservation information DB

1. A charger reservation system, comprising:
a reservation processing unit that receives a use reservation registration for a charger and manages reservation information containing a use starting date/time and a temporary use ending date/time; and
a charge required time calculation unit that calculates a time required for charging when a user starts using the charger based on the use reservation registration,
wherein the reservation processing unit calculates a new use ending date/time based on the time required for charging and updates the temporary use ending date/time to the new use ending date/time.

2. The charger reservation system according to claim 1, wherein, when the new use ending date/time is later than a use starting date/time set for a next reservation for the charger, the reservation processing unit updates the temporary use ending date/time to the use starting date/time set for the next reservation or a date/time that is earlier than the use starting date/time set for the next reservation by a certain time period.

3. The charger reservation system according to claim 1, wherein, when the new use ending date/time is earlier than the temporary use ending date/time, the reservation processing unit notifies a user, who has a reservation for the charger next, that a use starting date/time of the user can be pushed forward.

4. The charger reservation system according to claim 3, wherein, when a reservation for the use of the charger is registered, and a registration of a desired use starting date/time that overlaps with a usage time of other reservation is received, then the usage time no longer overlaps as a result of updating a temporary use ending date/time of the other reservation, the reservation processing unit updates the use starting date/time of the user to the desired use starting date/time.

5. The charger reservation system according to claim 1, wherein the charge required time calculation unit calculates the time required for charging based on at least one of a remaining capacity of a rechargeable battery to be charged, a temperature, and an output status of the charger.

6. A charger reservation apparatus, comprising:
a reservation processing unit that receives a use reservation registration for a charger and manages reservation information containing a use starting date/time and a temporary use ending date/time; and
a charge required time calculation unit that calculates a time required for charging when a user starts using the charger based on the use reservation registration,
wherein the reservation processing unit calculates a new use ending date/time based on the time required for charging and updates the temporary use ending date/time to the new use ending date/time.

7. A charger reservation method:
receiving a use reservation registration for a charger and managing reservation information containing a use starting date/time and a temporary use ending date/time;
calculating a time required for charging when a user starts using the charger based on the use reservation registration; and
calculating a new use ending date/time based on the time required for charging and then updating the temporary use ending date/time to the new use ending date/time.

8. A program that causes a computer to function as:
a reservation processing unit that receives a use reservation registration for a charger and manages reservation information containing a use starting date/time and a temporary use ending date/time; and
a charge required time calculation unit that calculates a time required for charging when a user starts using the charger based on the use reservation registration,
wherein the reservation processing unit calculates a new use ending date/time based on the time required for charging and updates the temporary use ending date/time to the new use ending date/time.

9. The charger reservation system according to claim 2, wherein, when the new use ending date/time is earlier than the temporary use ending date/time, the reservation processing unit notifies a user, who has a reservation for the charger next, that a use starting date/time of the user can be pushed forward.

10. The charger reservation system according to claim 9, wherein, when a reservation for the use of the charger is registered, and a registration of a desired use starting date/time that overlaps with a usage time of other reservation is received, then the usage time no longer overlaps as a result of updating a temporary use ending date/time of the other reservation, the reservation processing unit updates the use starting date/time of the user to the desired use starting date/time.

11. The charger reservation system according to claim 2, wherein the charge required time calculation unit calculates the time required for charging based on at least one of a remaining capacity of a rechargeable battery to be charged, a temperature, and an output status of the charger.
